(19) United States
(12) Patent Application Publication
(10) Pub. No.: US 2020/0387593 A1
(43) Pub. Date: Dec. 10, 2020

(54) Power Infrastructure Security System

(71) Applicant: LiiON industries, inc., West Dundee, IL (US)

(72) Inventors: Dean A. KOSTAN, West .Dundee, IL (US); Shawn T. SEGUR, South Barrington, IL (US); Tom LYNN, West Dundee, IL (US); Joshua S. BARNEY, West Dundee, IL (US); Gary L. GRAY, West Dundee, IL (US)

(73) Assignee: LiiON industries, inc., West Dundee, IL (US)

(21) Appl. No.: 16/971,361

(22) PCT Filed: Apr. 30, 2019
(86) PCT No.: PCT/US19/29943

§ 371 Date: Aug. 20, 2020

Related U.S. Application Data
(60) Provisional application No. 62/664,690, filed on Apr. 30, 2018.

(51) Int. Cl. G06F 21/44; G06F 21/55

(52) U.S. Cl. CPC G06F 21/44; G06F 21/552

(57) ABSTRACT

A distributed computing architecture is provided that decentralizes consensus with a continuously growing list of records (blocks), which are linked and secured using secure cryptography layered over stored and generated energy system management techniques. Data is stored in a nested contiguous arrangement of these blocks, and once a secure password is recorded, the data in any given block cannot be altered retroactively without the alteration of subsequent blocks, requiring the cooperation of the network majority.

### TECHNICAL FIELD

The present disclosure is related generally to power infrastructure and power storage resources and operation and, more particularly, to a system and method for protecting such resources and operations from unauthorized interference.

### BACKGROUND

The power infrastructure in the United States is a critical resource. However, in general, it is poorly protected against unauthorized interference, e.g., via hacked access. An unauthorized user who manages to gain access would be able to reallocate power, shut down systems, stress infrastructure elements, and otherwise weaken or damage the infrastructure elements. Such damage may include data unavailability, data destruction, server damage, unsolicited analytics, and unauthorized information access and manipulation.

Before proceeding, it should be appreciated that the present disclosure is directed to a system that may address some of the shortcomings listed or implicit in this Background section. However, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of one or more desirable courses of action reflects the inventors' own observations and ideas, and should not be assumed to indicate an art-recognized desirability.

### SUMMARY

The described systems and methods provide a distributed computing architecture that decentralizes consensus with a continuously growing list of records called blocks, which are linked and secured using secure cryptography layered over stored energy and generated energy system management techniques.

In an embodiment, data is stored in a nested concentric or coextensive arrangement of blocks. Once a secure password is recorded, the data in any given block cannot be altered retroactively without the alteration of all subsequent blocks, which requires collusion of the network majority.

In another embodiment, a security system is provided having one or more data recorders configured to create one or more records in a chained concentric or coextensive arrangement. A record linker is configured to link and secure the one or more records using secure cryptography. The record linker may be further configured to link the one or more records such that once a secure password is recorded, the data in a record cannot be retroactively altered without the alteration of all subsequent blocks.

Other features and aspects of the disclosed principles will be apparent from the detailed description taken in conjunction with the included figures, of which:

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified representation of the nested nature of data access in accordance with an embodiment of the disclosed principles; and

FIG. 2 is a schematic representation of an example arrangement of overlapping groups of contiguous rings of protection in accordance with an embodiment of the disclosed principles.

### DETAILED DESCRIPTION

As noted above, power infrastructure resources are often poorly protected against unauthorized interference. This is so, even though an unauthorized access event may lead to significant damage and disruption, even if data access is not attained by the unauthorized party. The present disclosure describes an enhanced concentric or coextensive block security infrastructure, embodiments of which eliminate or reduce risks posed by current security systems.

In an embodiment of the disclosed principles, energy modules and systems are protected and secured by utilizing a novel form of blockchain security, ensuring that systems are controlled, managed and maintained by only those parties that are authorized to do so. This assists in ensuring that that data centers, for example, and their data are secure. The energy system blockchain security described herein (or “contiguous nested encryption”) is an intelligent, secure, distributed system configured to share encrypted transactions with other energy systems via a cloud-based network, local area network or isolated local network system.

The contiguous nested encryption system is configured to provide an accounting of energy units that can be bought, sold, traded or held and utilized as a financial commodity or instrument in either a closed system or open marketplace with a capability to trade, disburse or deposit energy units via network (WAN, LAN, PAN), ATM, computer, phone, mobile, remote, or location based device. For example, energy modules and related systems may be configured to await favorable electricity prices before deciding when to charge itself from the grid. The contiguous nested encryption system can handle the necessary accounting tasks among all the involved parties, e.g., OEM and Partner energy modules and systems. Customized blocks can also be reserved and utilized for future partners and energy systems via an energy API method and system.

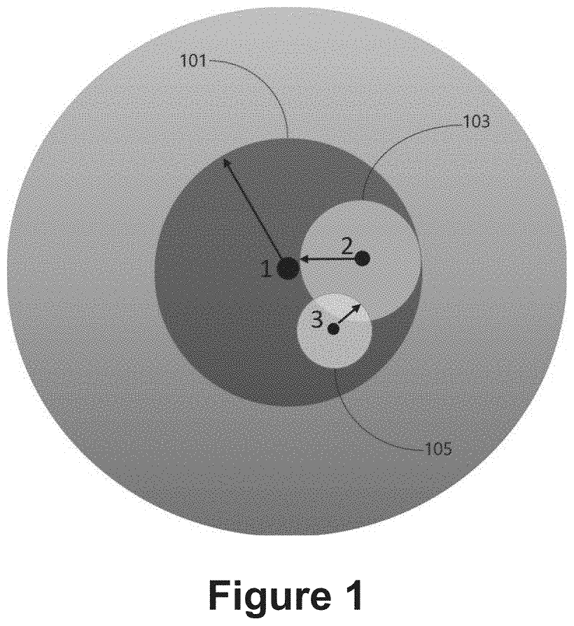

FIG. 1 is a simplified representation of the nested nature of data access in accordance with an embodiment of the disclosed principles, wherein a client (or end user), OEM and security provider have access to the contiguous closed loop blockchain security network. In particular, there is a first blockchain loop 101 associated with client, and with the first loop 101, a second OEM loop 103 and third security provider loop 105.

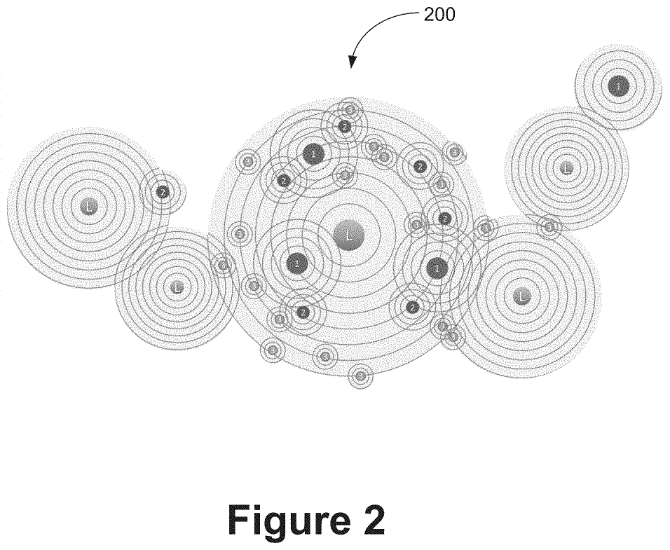

Although the simplified representation of FIG. 1 shows a single level of nesting, it will be appreciated that any number of nested, contiguous and/or overlapping loops may be implemented. In this regard, FIG. 2 is a schematic representation of an arrangement of overlapping groups of contiguous rings of protection in accordance with an embodiment of the disclosed principles.

In an embodiment, the contiguous nested encryption system is setup and organized in a distributed arrangement having a ledger of verifiable and historical transactions using hash-based signatures. The ledger is configured to store keys, prune and compress records, verify individual and group membership, and store energy units via an aggregator, sensor (slave) model using hash chain, symmetric and/or asymmetric encryption.

The energy modules and systems may be configured to provide dynamic but verifiable group membership, provide authentication & data integrity, and/or secure against key leakage, e.g., for a single-node or a small sub-set of nodes. The system operations are lightweight with respect to resources. While encryption is often desirable, it is not a requirement of every embodiment.

In an embodiment, the system is configured to handle sensor “sleep/power off” periods and to manage resource diversity and data and sensor aggregators. In an embodiment, in the event of an attempted hack/breach in software, or physical tampering removal, the system is configured to turn off and/or disable any or all functions, data access and use of power.

The blockchain portion of the described energy system architecture is not only lateral but contiguous in nature, thus providing the capability to associate with as well as inherit other blockchains in an extensible and flexible, interconnected loop, which is itself made up of loops. This flexible and adaptable architecture thus allows for easy integration with other blockchains, systems, networks, devices, partners and more.

The described system is especially beneficial for OEM partners who wish to integrate into the blockchain architecture. OEMs can be allocated or assigned a customizable block with a predictable and canonical tag in the ledger which will enable one to identify, track and share statistics and information including but not limited to uptime, units, temperature, and energy currency.

Although the described system provides security that is unlikely to be bypassed, the system also embodies a fail-safe in an embodiment. In particular, an anti-theft feature may be incorporated into the battery management system that disables connectivity and data access to the battery management system and subsequent blockchain (and system) blocks if one or more energy modules is compromised including but not limited to being tampered with, hacked/breached, stolen, removed, turned-off, or destroyed. Thus, in the event a battery is compromised, the energy module and/or battery will not work, independent of the system through means of, but not limited to, proximity, password, hash, or encrypted key. The energy system is resilient and, because of this unique architecture, will ensure that the overall stability and availability of the energy system will not be compromised despite the status of any one or more compromised modules. The anti-theft feature of the described system would also permit the tracking or tracing of the access path or theft of energy modules or other compromised elements.

Although the described examples pertain to energy system security, any type of electronically-monitored or accessed device or entity, even human beings and animals, can also be protected and secured by utilizing the described contiguous blockchain system, ensuring that valuable data or entities are secure. This distributed system also has the ability to share and secure encrypted transactions between entities via any communication channel or electronic device, including but not limited to WAN, LAN, PAN, mobile device, computer, remotely accessed digital device, energy module and system, a location based device or service, or an implanted digital interface with an embedded System on Chip (SoC).

In an embodiment, a dynamic and secure contiguous blockchain network is established when a device or person having the blockchain interface or application is connected to another such device or person. As noted above, once established, the distributed network embodies a self-organizing, distributed arrangement with a ledger of verifiable and historical transactions using hash-based signatures.

In an embodiment, the energy system is configured to hear, play, record and transfer audio within the blockchain. Allocating sound as an additional “mode” within the blockchain provides another level of security as each block will have a frequency and harmonic signature that is unique from another. Moreover, the system may be secured in another dimension (so that the system may be considered to secure in “4D”). For example, security can be increased by configuring the system so that data can only be changed at a certain date/day and time, or only on a phased or rolling schedule. In this embodiment, since only the inside members will know the permitted change windows, most unauthorized access attempts will necessarily fail and will, moreover, be particularly simple to detect.

It will be appreciated that various systems and processes have been disclosed herein. However, in view of the many possible embodiments to which the principles of the present disclosure may be applied, it should be recognized that the embodiments described herein with are meant to be illustrative only and should not be taken as limiting the scope of the claims. Therefore, the techniques as described herein contemplate all such embodiments as may come within the scope of the following claims and equivalents thereof.

We claim:

1. An energy security and management system comprising:
one or more modules connected in a network;
a secure ledger distributed among the network, the ledger comprising one or more blocks, and each block storing at least one block datum;
at least one block linker configured to create an encrypted, directional link between each block and a subsequent block; and
one or more energy units, each unit corresponding to a financial commodity capable of being transacted;
wherein the ledger is secured using encryption such that the at least one block datum stored in each block cannot be retroactively altered without altering all subsequently linked blocks in the ledger; and
wherein the system is configured to securely and verifiably manage all energy unit transactions within the network.

2. The system of claim 1, wherein the at least one block datum corresponds to an energy unit transaction involving the one or more modules.

3. The system of claim 1, wherein the one or more linked blocks are linked in any combination of concentric and/or contiguous links.

4. The system of claim 1, wherein the system is further configured to securely and verifiably manage all energy unit transactions between the network and a second network, and/or between the network and an open marketplace.

5. The system of claim 1, wherein each module is further configured to:
provide a module membership and a module authentication,
store and secure at least one module datum,
store and secure at least one key, and
securely access the system.

6. The system of claim 5, wherein the ledger is further configured to:
authenticate the module membership and the module authentication,
store and secure the at least one key, and
prune and compress the one or more blocks.

7. The system of claim 5, wherein each module is assigned a customizable block using a canonical tag in the ledger, the canonical tag identifying the module and enabling access to the module datum.

8. The system of claim 1, further comprising:
at least one sensor;
at least one sensor aggregator; and
at least one data aggregator;
wherein the system is further configured to securely and verifiably manage the at least one sensor, the at least one sensor aggregator, the at least one data aggregator, and a power cycle and a resource distribution for the at least one sensor, the at least one sensor aggregator, and the at least one data aggregator.

9. The system of claim 1, wherein in the event of an attempted software attack or hardware attack, the system is configured to disable some or all functionality.

10. The system of claim 9, further comprising a battery management system;
wherein in the event of an attempted software attack or hardware attack on the one or more modules, the battery management system is configured to disable some or all functionality of the one or more modules.

11. The system of claim 1, wherein each block is assigned a unique frequency and harmonic signature; and
wherein the system is further configured to manage and transduce audio.

12. The system of claim 1, wherein the system is further configured to be only accessible during a predetermined window of time or predetermined schedule.

13. The system of claim 1, wherein the network is further configured to be securely accessible by an electronic device.

14. A security and management system comprising:
one or more entities connected in a network;
a secured ledger distributed among the network, the ledger comprising one or more blocks, and each block storing at least one block datum;
at least one block linker configured to create an encrypted, directional link between each block and a subsequent block; and
one or more currency units capable of being transacted in a currency unit transaction;
wherein the at least one block datum corresponds to a currency unit transaction involving the one or more entities;
wherein the ledger is secured using encryption such that the at least one block datum stored in each block cannot be retroactively altered without altering all subsequently linked blocks in the ledger; and
wherein the system is configured to securely and verifiably manage all currency unit transactions within the network, between the network and a second network, and between the network and an open marketplace.

15. The system of claim 14, wherein the one or more blocks are linked in any combination of concentric and/or contiguous links.

16. The system of claim 14, wherein each block is assigned a unique frequency and harmonic signature;
wherein the system is further configured to manage and transduce audio; and
wherein the system is further configured to be only accessible during a predetermined window of time or predetermined schedule.

17. An energy security and management method comprising the steps of:
acquiring one or more modules;
connecting the one or more modules in a network;
creating at least one block and storing at least one block datum in the block;
creating an encrypted, directional link between the block and a subsequent block;
creating a secure ledger of blocks and links such that the at least one block datum in each block cannot be retroactively altered without altering all subsequently linked blocks in the ledger;
securely distributing the ledger among the network;
securely and verifiably transacting one or more energy units corresponding to a financial commodity; and
accounting all of the energy unit transactions within the network.

18. The method of claim 17, further comprising the steps of:
connecting the network to a second network and/or connecting the network to an open marketplace; and
accounting all of the energy unit transactions between the network and the second network, and/or between the network and the open marketplace.

19. The method of claim 17, further comprising the steps of:
providing a module membership and a module authentication for each module;
authenticating the module membership and module authentication with the ledger;
storing and securing at least one module datum in each module;
storing and securing at least one key in each module and in the ledger; and
pruning and compressing the one or more blocks.

20. The method of claim 17, further comprising the step of disabling some or all functionality in the event of an attempted software attack or hardware attack.
